(19) United States
(12) Patent Application Publication
(10) Pub. No.: US 2026/0342611 A1
(43) Pub. Date: Oct. 29, 2026

(54) TRANSCEIVER, METHOD FOR ACTIVATING TRANSCEIVER, AND COMMUNICATION SYSTEM

(71) Applicant: DENSO CORPORATION, Kariya-shi (JP)

(72) Inventors: Yasuhiro KOTANI, Kariya-shi (JP); Mao YAMAUCHI, Kariya-shi (JP)

(21) Appl. No.: 19/433,565

(22) Filed: Dec. 26, 2025

(30) Foreign Application Priority Data
Jan. 31, 2025 (JP) 2025-015178

(51) Int. Cl. H04L 12/40

(52) U.S. Cl. CPC H04L 12/40071; H04L 12/40039

(57) ABSTRACT

A transceiver, which is connected to an on-board communication line, includes a detection unit configured to detect standardized signals communicated on the on-board communication line. The standardized signals are standardized on the on-board communication line, and includes a first activation signal and a second activation signal. After the detection unit detects the first activation signal on the on-board communication line, the transceiver is configured to be completely activated in response to the detection unit detecting the second activation signal on the on-board communication line within a predetermined period of time after detection of the first activation signal. The second activation signal is different from the first activation signal, and includes identification information for identifying the transceiver.

### CROSS REFERENCE TO RELATED APPLICATION

The present application claims the benefit of priority from Japanese Patent Application No. 2025-015178 filed on Jan. 31, 2025. The entire disclosure of the above application is incorporated herein by reference.

### TECHNICAL FIELD

The present disclosure relates to a communication technology for performing communication via an on-board communication line.

### BACKGROUND

Conventionally, an on-board system includes multiple on-board ECUs and on-board devices, which are connected to an on-board communication line. The multiple on-board ECUs are connected, using a bus, to an on-board communication line through a communication cutoff unit. The on-board device outputs a cutoff signal to a communication cutoff unit included in a target on-board ECU for which activation is not required. Thus, the target on-board ECU for which activation is not required is disconnected from the on-board communication line. Thereafter, the on-board device transmits an activation signal to the on-board ECU for activating the on-board ECU. With this configuration, the on-board ECU for which activation is not required is maintained in deactivated state. Thus, the on-board system can reduce consumption power by keeping the on-board ECU for which activation is not required in the deactivated state.

### SUMMARY

According to an aspect of the present disclosure, a transceiver is connected to an on-board communication line, and includes at least one circuit including a detection unit. The detection unit is configured to detect standardized signals communicated on the on-board communication line. The standardized signals are standardized on the on-board communication line, and include a first activation signal and a second activation signal. After the detection unit detects the first activation signal on the on-board communication line, the transceiver may be completely activated in response to the detection unit detecting the second activation signal on the on-board communication line within a predetermined period of time after detection of the first activation signal. The second activation signal is different from the first activation signal and includes identification information for identifying the transceiver.

### BRIEF DESCRIPTION OF DRAWINGS

Features of the present disclosure will become apparent from the following detailed description made with reference to the accompanying drawings. In the drawings:

FIG. 1 is a diagram showing an exemplary configuration of a communication system according to a first embodiment of the present disclosure;

FIG. 2 is a diagram showing a configuration of an ECU included in the communication system according to the first embodiment;

FIG. 3 is a block diagram showing a functional configuration of a transceiver according to the first embodiment;

FIG. 4 is a diagram showing a format of an NM message according to the first embodiment;

FIG. 5 is a flowchart showing a process executed by a transceiver of an activated node for activating another node according to the first embodiment;

FIG. 6 is a flowchart showing an activation process executed by a transceiver of a sleep state node according to the first embodiment;

FIG. 7 is a flowchart showing a process executed by a transceiver of an activated node for activating another node according to a second embodiment; and

FIG. 8 is a flowchart showing a process executed by an activated controller for activating another node according to the second embodiment.

### DETAILED DESCRIPTION

In the above-described on-board system according to the related art, the on-board device is connected to the on-board communication line, and is also connected to each communication cut-off unit through a signal line. The on-board device needs to output a cut-off signal through the signal line to each communication cut-off unit for controlling corresponding on-board ECU for which activation is not required.

According to an aspect of the present disclosure, a transceiver connected to an on-board communication line is provided. The transceiver includes at least one circuit including a detection unit. The detection unit is configured to detect standardized signals communicated on the on-board communication line. The standardized signals are standardized on the on-board communication line, and include a first activation signal and a second activation signal. After the detection unit detects the first activation signal on the on-board communication line, the transceiver is configured to be completely activated in response to the detection unit detecting the second activation signal on the on-board communication line within a predetermined period of time after detection of the first activation signal. The second activation signal is different from the first activation signal and includes identification information for identifying the transceiver.

In the above configuration, the transceiver is completely activated when the standardized second activation signal is detected within the predetermined period of time from detection time of the standardized first activation signal. Therefore, the transceiver can be activated on a node-by-node basis in response to the standardized signal on the on-board communication line.

According to another aspect of the present disclosure, a method for activating a transceiver, which is connected to an on-board communication line, is provided. The method includes detecting a first activation signal communicated on the on-board communication line. The first activation signal is a signal standardized on the on-board communication line. After detecting the first activation signal on the on-board communication line, in response to detecting a second activation signal on the on-board communication line within a predetermined period of time after detection of the first activation signal, the transceiver is completely activated. The second activation signal is a signal standardized on the on-board communication line. The second activation signal is different from the first activation signal and includes identification information for identifying a network to which the transceiver is included.

The method for activating the transceiver provides the same effects as the above-described transceiver.

According to another aspect of the present disclosure, a communication system is provided. The communication system includes a transmitting device, a receiving device, a control device, and an on-board communication line. The transmitting device, the receiving device, and the control device are connected to the on-board communication line. The transmitting device is configured to generate and transmit a first activation signal to the on-board communication line. The first activation signal is a signal standardized on the on-board communication line. The receiving device is configured to receive signals standardized on the on-board communication line. The control device is configured to be completely activated when the receiving device receives a second activation signal, which is different from the first activation signal, within a predetermined period of time after receiving the first activation signal. The second activation signal includes identification information for identifying the receiving device on the on-board communication line.

According to the above communication system, each node connected to the on-board communication line can be individually activated in response to a request from another node.

According to another aspect of the present disclosure, a communication system includes a transmitting device, a receiving device, a first control device, a second control device, and an on-board communication line. The transmitting device, the receiving device, the first control device, and the second control device are connected to the on-board communication line. The transmitting device is configured to generate and transmit a first activation signal, which is a signal standardized on the on-board communication line. The first control device is configured to generate and transmit a second activation signal, which is a signal standardized on the on-board communication line after the first activation signal is transmitted to the on-board communication line. The second activation signal includes identification information for identifying the receiving device connected to the on-board communication line. The receiving device is configured to receive the signals standardized on the on-board communication line. The second control device is completely activated in response to the receiving device receiving the second activation signal within a predetermined period of time after receiving the first activation signal.

According to the above communication system, the first control device generates the second activation signal. Thus, it is possible to individually activate a node connected to the on-board communication line and can also reduce the load of the transmitting device.

The following will describe embodiments of the present disclosure with reference to accompanying drawings.

### 1. First Embodiment

### 1-1. Configuration

### 1-1-1. Configuration of on-board communication system

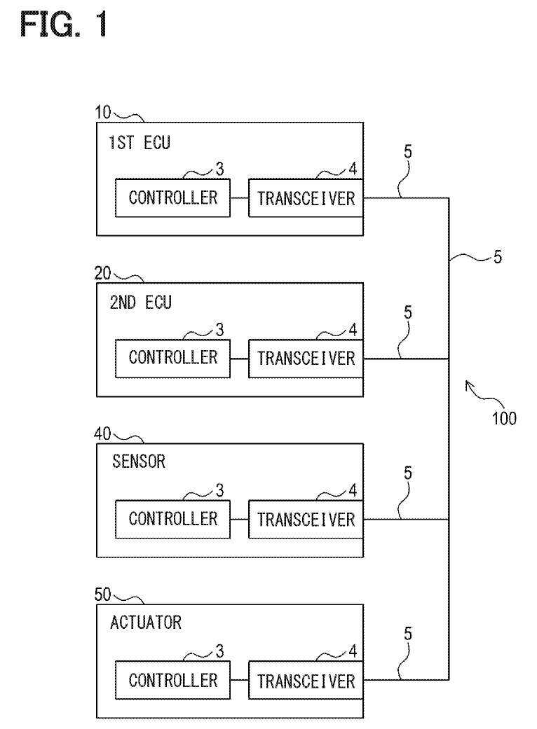

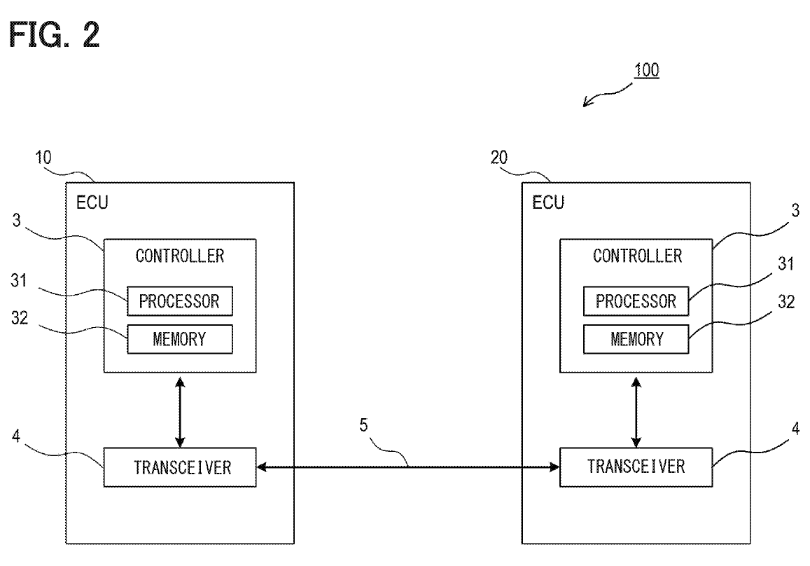

The following will describe a configuration of an on-board communication system 100 according to the present embodiment with reference to FIGS. 1 and 2. The on-board communication system 100 is mounted on a vehicle, and includes an on-board communication line 5 and multiple nodes connected to the on-board communication line 5.

The on-board communication line 5 is configured by an Ethernet signal line compatible with the Ethernet (registered trademark) protocol. Specifically, the on-board communication line 5 is a bus-type Ethernet communication line. The on-board communication line 5 may be an Ethernet communication line defined under 10BASE-T1S. In another embodiment, the on-board communication line 5 is not limited to a bus-type Ethernet communication line, but may be a star-type Ethernet communication line such as 10BASE-T1. Alternatively, the on-board communication line 5 may be a communication line that supports a protocol other than Ethernet. For example, the on-board communication line 5 may be a Controller Area Network (CAN) communication line compatible with the CAN protocol, or a FlexRay communication line compatible with the FlexRay protocol.

The multiple nodes include a first electronic control unit (ECU) 10, a second ECU 20, a sensor 40, and an actuator 50. The first ECU 10 is, for example, a right front door ECU of the vehicle, and controls the locking and unlocking of the right front door and the opening and closing of the power window. The second ECU 20 is, for example, a left front door ECU of the vehicle, and controls the locking and unlocking of the left front door and the opening and closing of the power window. The sensor 40 is, for example, a door sensor that detects whether a door is open or closed. The actuator 50 is, for example, a motor that generates a driving force for opening and closing the power window. In another embodiment, the first ECU 10 may be an Ethernet switch, and may be connected to other ECUs, for example, domain ECUs or zone ECUs which are not shown in the drawing. The multiple nodes may be any combination of ECUs, sensors, actuators, or the like.

The first ECU 10, the second ECU 20, the sensor 40, and the actuator 50 each includes a controller 3 and a transceiver 4.

The controller 3 includes a processor 31 and a memory 32. The processor 31 executes various programs stored in the memory 32 to execute various processes. For example, the controller 3 executes a process related to communication via the on-board communication line 5. The memory 32 includes, for example, a random access memory (RAM) and a flash memory. The RAM is used as a working area when the processor 31 executes the process. The flash memory stores programs. The controller 3 corresponds to a control unit and a second communication device of the present disclosure.

The transceiver 4 is an interface implemented in the physical layer of OSI reference model, that is, implemented by hardware logic circuit. Specifically, the transceiver 4 is a physical layer transceiver (specifically PHY) that complies with the Ethernet protocol defined under 10BASE-T1S. The transceiver 4 is directly connected to the on-board communication line 5. The controller 3 is connected to the transceiver 4 by a signal line, and is connected to the on-board communication line 5 through the transceiver 4. The transceiver 4 communicates with other transceivers 4 via the on-board communication line 5. The transceiver 4 transmits various data to the on-board communication line 5 and receives various data from the on-board communication line 5. In the present embodiment, the transceiver 4 of the first ECU 10 corresponds to a transmitting device of the present disclosure, and the controller 3 of the first ECU 10 corresponds to a first control device of the present disclosure. The transceiver 4 of the second ECU 20 corresponds to a receiving device of the present disclosure, and the controller 3 of the second ECU 20 corresponds to a control device and a second control device of the present disclosure.

### 1-1-2. Configuration of transceiver

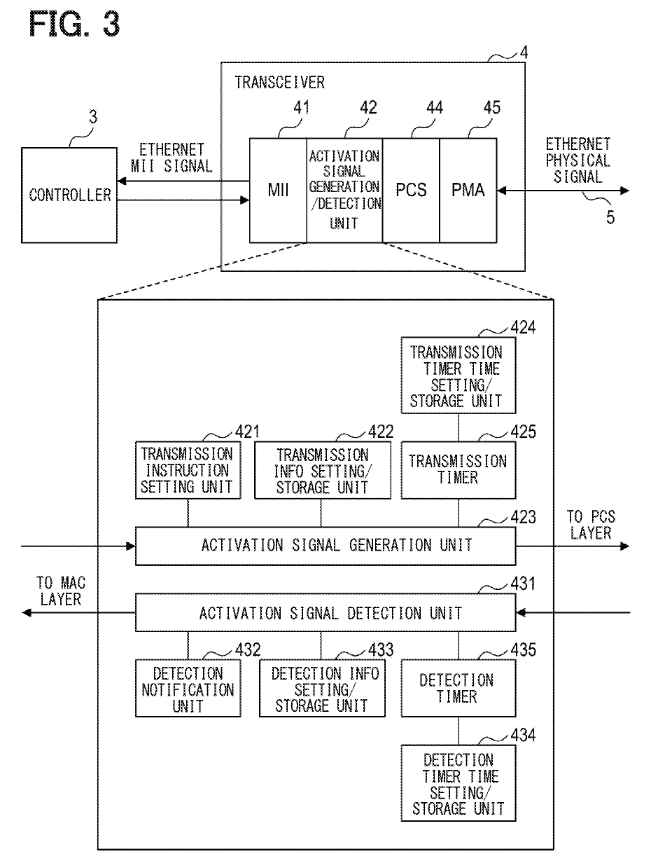

An example of a functional configuration of the transceiver 4 will be described with reference to FIG. 3. The transceiver 4 includes a Media Independent Interface (MII) 41, an activation signal generation/detection unit 42, a Physical Coding Sublayer (PCS) 44, and a Physical Media Attachment (PMA) 45. The MII 41, the activation signal generation/detection unit 42, the PCS 44, and the PMA 45 are arranged in described order between the controller 3 and the on-board communication line 5. The MII 41 is arranged closest to the controller 3.

The MII 41 is an interface between the physical layer and Media Access Control (MAC) layer. The MAC is implemented in the data link layer of OSI reference model based on IEEE 802.3, which is the Ethernet standard. The MAC is included in the controller 3. The MII 41 receives transmission data in the Ethernet MII format from the MAC, and transmits the transmission data to the activation signal generation/detection unit 42. The MII 41 receives reception data from the activation signal generation/detection unit 42, and then transmits the reception data to the MAC in the Ethernet MII format.

In an activated state of the transceiver 4, in response to the activation signal generation/detection unit 42 receiving a transmission instruction of activation signal from the controller 3 via the MII 41, the activation signal generation/detection unit 42 generates a first activation signal and transmits the generated first activation signal as transmission data. The activation signal generation/detection unit 42 generates and transmits a second activation signal as transmission data within a predetermined period of time from a transmission time of the first activation signal.

When the activation signal generation/detection unit 42 receives a first activation signal from the on-board communication line 5 via the PMA 45 and the PCS 44, the activation signal generation/detection unit 42 activates partial functions of the transceiver 4, which is in a sleep state. That is, the activation signal generation/detection unit 42 increases the number of activation functions (that is, function of power supply) of the transceiver 4 in sleep state. In the sleep state, some functions of the transceiver 4 are activated by power supply, while other functions are in deactivated state. Then, when the activation signal generation/detection unit 42 receives the second activation signal within a predetermined period of time from the reception time of the first activation signal, the transceiver 4 is completely activated by the activation signal generation/detection unit 42. Then, the activation signal generation/detection unit 42 activates the controller 3 completely.

In the sleep state, the transceiver 4 stops processing executed by the communication layer and is only able to detect physical layer signal, but is unable to interpret data link layer or network layer messages. The first activation signal is a physical layer signal, which is a trigger for switching the transceiver 4 from the sleep state to a state in which the transceiver 4 can interpret messages from the data link layer or the network layer. For example, the first activation signal is a wake-up pulse (WUP) or a wake-up request (WUR). The WUP/WUR is compatible with Technical Committee (TC) 10 defined by the One-Pair Ether-Net Alliance.

The second activation signal switches the transceiver 4, which matches the identification information, from a partially activated state to a completely activated state, and switches the controller 3, which controls the transceiver 4, from a sleep state to a normal state. The second activation signal is a signal corresponding to the data link layer or the network layer, and includes identification information for identifying the transceiver 4 connected to the on-board communication line 5.

For example, the second activation signal is a Network Management (NM) message. The NM message is used in User Datagram Protocol Network Management (UDPNM). UDPNM is defined by the AUTomotive Open System Architecture (AUTOSAR), a global development partnership of the automotive industry.

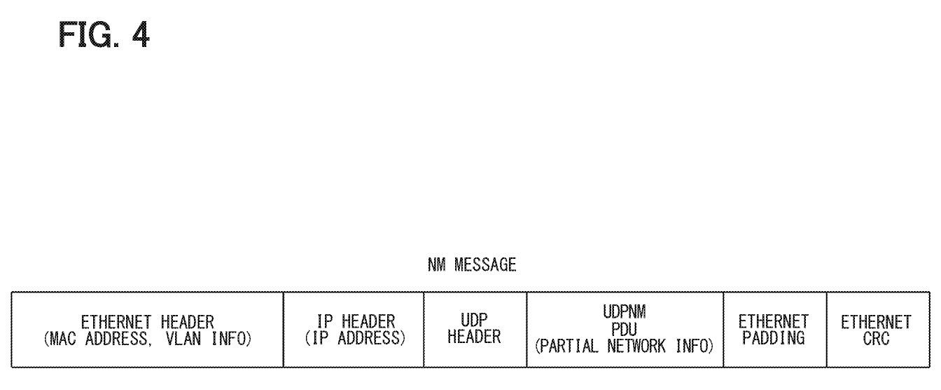

FIG. 4 shows a data format of the NM message. The NM message includes an Ethernet header, an IP header, a UDP header, a User Datagram Protocol Network Management Protocol Data Unit (UDPNMPDU), Ethernet padding, and an Ethernet Cyclic Redundancy Check (CRC). The identification information may be the MAC address or Virtual Local Area Network (VLAN) information of the node contained in the Ethernet header. The MAC address is an identification number assigned to each node device to be different from other nodes. The VLAN information is, for example, a VLAN ID, which is the identification number of the VLAN to which the node belongs. The identification information may also be the IP address of the node contained in the IP header. The identification information may also be Partial Network Information (PNI) included in the UDPNMPDU. The PNI indicates whether or not there is an activation request for each partial network. In a case where the NM message includes an activation request for the partial network to which the transceiver 4 belongs, the identification information matches or corresponds to the transceiver 4.

The activation signal generation/detection unit 42 has the functions of a transmission instruction setting unit 421, a transmission information setting/storage unit 422, an activation signal generation unit 423, a transmission timer time setting/storage unit 424, a transmission timer 425, an activation signal detection unit 431, a detection notification unit 432, a detection information setting/storage unit 433, a detection timer time setting/storage unit 434, and a detection timer 435.

The transmission instruction setting unit 421 receives, from the controller 3, a transmission instruction that instructs transmission of an activation signal, and passes the transmission instruction to the activation signal generation unit 423. The transmission information setting/storage unit 422 sets and stores pattern information of the second activation signal. For example, the transmission information setting/storage unit 422 sets, as the pattern information, a correspondence between an activation cause of own node and an activation target node to be activated by own node.

The activation signal generation unit 423 generates a first activation signal in response to receiving the transmission instruction from the transmission instruction setting unit 421, and transmits the first activation signal to the on-board communication line 5 via the PCS 44 and the PMA 45. The activation signal generation unit 423 generates a second activation signal based on the pattern information of second activation signal stored in the transmission information setting/storage unit 422. For example, the activation signal generation unit 423 generates the second activation signal based on the activation cause of own node, which is included in the transmission instruction, and the above-described correspondence relationship.

The transmission timer time setting/storage unit 424 sets and stores a transmission interval between the first activation signal and the second activation signal. The transmission interval may be set to the same interval for all nodes connected to the on-board communication line 5, or may be set to different intervals for individual VLANs or individual partial networks. The transmission timer time setting/storage unit 424 may be configured to update the transmission interval. The transmission timer 425 counts the elapsed time since the first activation signal was transmitted. When the elapsed time from the transmission of the first activation signal reaches the stored transmission interval, the transmission timer 425 transmits the second activation signal to the on-board communication line 5 via the PCS 44 and the PMA 45.

The activation signal detection unit 431 detects standardized signals transmitted by another node to the on-board communication line 5. The standardized signals include a first activation signal and a second activation signal. The detection notification unit 432 notifies the controller 3 that the activation signal detection unit 431 has detected the first activation signal and the second activation signal. The detection information setting/storage unit 433 sets and stores pattern information of the second activation signal detected by the activation signal detection unit 431.

The detection timer time setting/storage unit 434 sets and stores the maximum reception interval between the first activation signal and the second activation signal. The reception interval may be set to the same interval for all nodes connected to the on-board communication line 5, or may be set to different intervals for individual VLANs or individual partial networks. For example, the detection timer time setting/storage unit 434 sets the reception interval for a specific VLAN to be longer than the transmission interval set by the specific VLAN. The detection timer time setting/storage unit 434 may be configured to update the reception interval.

The detection timer 435 counts the elapsed time since the first activation signal was detected by the activation signal detection unit 431. When the detection timer 435 receives the second activation signal within the reception interval, that is, the elapsed time period from the reception time of first activation signal does not yet reach the stored reception interval, the detection timer 435 transmits the second activation signal to the activation signal detection unit 431. When the detection timer 435 receives the second activation signal after the elapsed reception time has exceeded the reception interval, the detection timer 435 ignores the second activation signal and does not transmit the second activation signal to the activation signal detection unit 431.

The activation signal detection unit 431 detects the second activation signal transmitted from the detection timer 435 and determines whether the identification information included in the second activation signal corresponds to own node. When the identification information included in the second activation signal corresponds to own node, the detection notification unit 432 notifies the controller 3 that the second activation signal corresponding to own node has been detected.

When the controller 3 receives a notification from the transceiver 4 about detection of the first activation signal and also receives a notification from the transceiver about detection of the second activation signal corresponding to own node, the controller 3 switches from the sleep state to the normal state and is activated. In the sleep state, only partial function of the controller 3 is in activated state by receiving power supply, and other functions are in deactivated state. In the normal state, all of the functions of the controller 3 receive power supply and are in activated state.

The PCS 44 encodes the transmission data received from the activation signal generation/detection unit 42 to generate a transmission code, and transmits the transmission code to the PMA 45. For example, the PCS 44 performs 4B/3B conversion or scrambling on the transmission data to generate the transmission code. The PCS 44 also decodes the code received from the PMA 45 to generate the reception data, and transmits the reception data to the activation signal generation/detection unit 42.

The PMA 45 converts the transmission code (i.e., bit data) received from the PCS 44 into a physical layer signal (i.e., an electrical signal) and transmits the physical layer signal to a physical medium for transmission via a Medium Dependent Interface (hereinafter, MDI). The physical medium for transmission corresponds to the Ethernet signal line that constitutes the on-board communication line 5. The PMA 45 also converts a physical layer signal (i.e., an electrical signal) received from a transmission physical medium via the MDI into a reception code (i.e., bit data), and transmits the reception code to the PCS 44.

### 1-2. Process

### 1-2-1. Process for activating another node by an activated transceiver

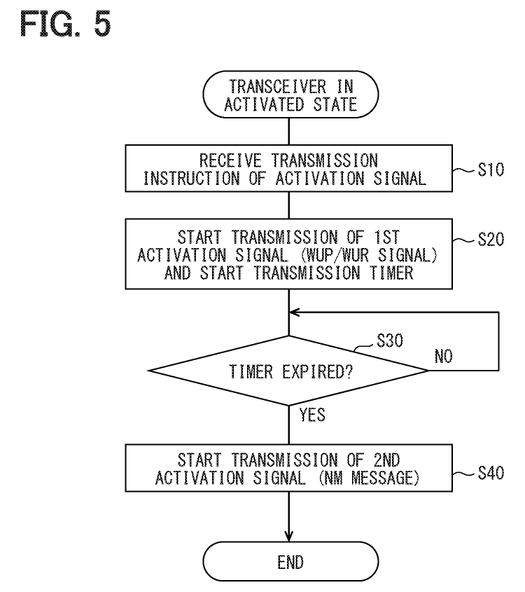

The following will describe a process for activating another node, which is executed by an activated transceiver 4 with reference to FIG. 5. The transceiver 4 starts the activating process upon receiving, from the controller 3, a transmission instruction of activation signal.

In S10, the transceiver 4 receives the transmission instruction of activation signal from the controller 3. For example, the controller 3 transmits the transmission instruction of activation signal to the transceiver 4 in order to activate a specific node for starting an application of own node.

In S20, the transceiver 4 receives the transmission instruction of activation signal, generates the first activation signal, and starts transmission of the first activation signal. The transceiver 4 also starts the transmission timer from the transmission start time of the first activation signal.

In S30, the transceiver 4 determines whether the transmission timer has expired. That is, the transceiver 4 determines whether the transmission timer has reached the stored transmission interval. When the transceiver 4 determines that the transmission timer has expired, the transceiver 4 proceeds to S40. When the transceiver determines that the transmission timer has not expired, the process repeats S30.

In S40, the transceiver 4 generates the second activation signal and starts transmission of the second activation signal. Thereafter, the transceiver 4 ends the current process.

### 1-2-2. Process for activating own node by a sleep-state transceiver of own node

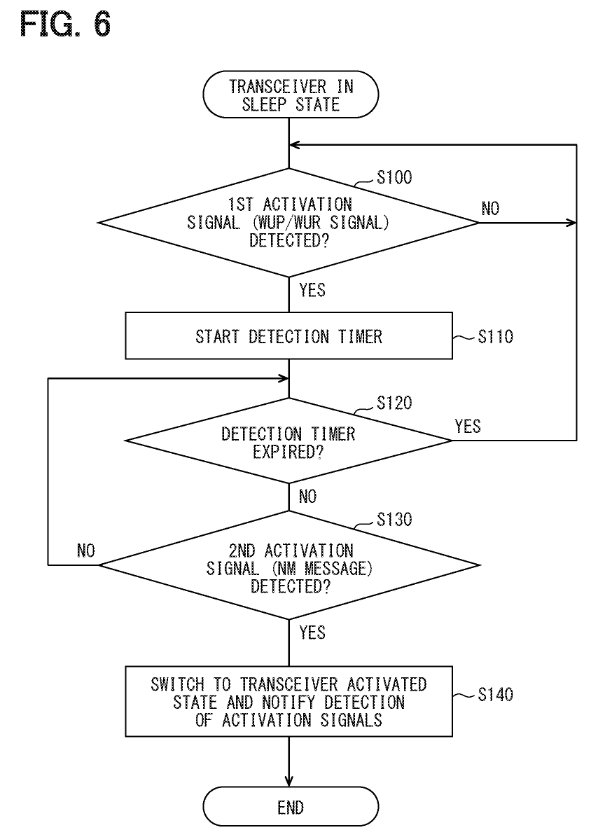

The following will describe a process for activating own node, which is executed by a sleep-state transceiver 4 of own node, with reference to FIG. 6. In the sleep state, the transceiver 4 repeatedly executes this process at predetermined intervals.

In S100, the transceiver 4 determines whether the first activation signal has been detected. When the transceiver 4 determines that the first activation signal has been detected, the process proceeds to S110. When the transceiver 4 determines that the first activation signal has not been detected, the process repeats S100.

In S110, the transceiver 4 starts a detection timer from the detection time point of the first activation signal.

In S120, the transceiver 4 determines whether the detection timer has expired. That is, the transceiver 4 determines whether the detection timer has reached the stored reception interval. When the transceiver 4 determines that the detection timer has expired, the process returns to S100. That is, the transceiver 4 maintains the sleep state because the second activation signal is not detected within a predetermined period of time after the first activation signal is detected. When the transceiver 4 determines that the detection timer has not expired, the process proceeds to S130.

In S130, the transceiver 4 determines whether the second activation signal has been detected. When the transceiver 4 determines that the second activation signal has been detected, the process proceeds to S140. When the transceiver 4 determines that the second activation signal has not been detected, the process returns to S120.

In S140, the transceiver 4 switches from the partially activated state to the completely activated state. That is, the transceiver 4 activates the power supply paths to all the functional units of the transceiver 4. The transceiver 4 also notifies the controller 3 about detection of the first activation signals and the second activation signal. Thereafter, the process is ended.

### 1-3. Effects

The first embodiment described above has the following advantages.
(1) The transceiver 4 is completely activated when the standardized second activation signal is detected within a predetermined period of time after the standardized first activation signal is detected. Therefore, the transceivers 4 of multiple nodes can be individually activated on a node-by-node basis in response to the standardized signal communicated on the on-board communication line 5.
(2) The transceiver becomes able to detect the identification information included in the second activation signal after receiving the first activation signal. When the transceiver receives the second activation signal within a predetermined period of time from the reception time of the first activation signal, the transceiver can activate all of own functions.
(3) The transceiver 4 can start the transmission timer in response to receiving a signal corresponding to TC10.
(4) The transceiver 4 can activate all functions in response to receiving an NM message using UDP as specified by AUTOSAR.
(5) The transceiver 4 can be completely activated when the VLAN ID included in the second activation signal corresponds to own node.
(6) The transceiver 4 can be completely activated when the PNI included in the second activation signal corresponds to own node.

### 2. Second Embodiment

### 2-1. Differences from the first embodiment

The basic configuration of second embodiment is similar to that of the first embodiment. Therefore, the difference therebetween will be mainly described below. The same reference symbol as in the first embodiment denote the same element, and reference is made to the preceding description.

In the above-described first embodiment, the transceiver 4 in the activated state generates and transmits the first activation signal and the second activation signal. The second embodiment differs from the first embodiment in that the transceiver 4 in the activated state generates and transmits the first activation signal, and the controller 3 in an activated state generates and transmits the second activation signal.

### 2-2. Process for activating another node by an activated transceiver and controller

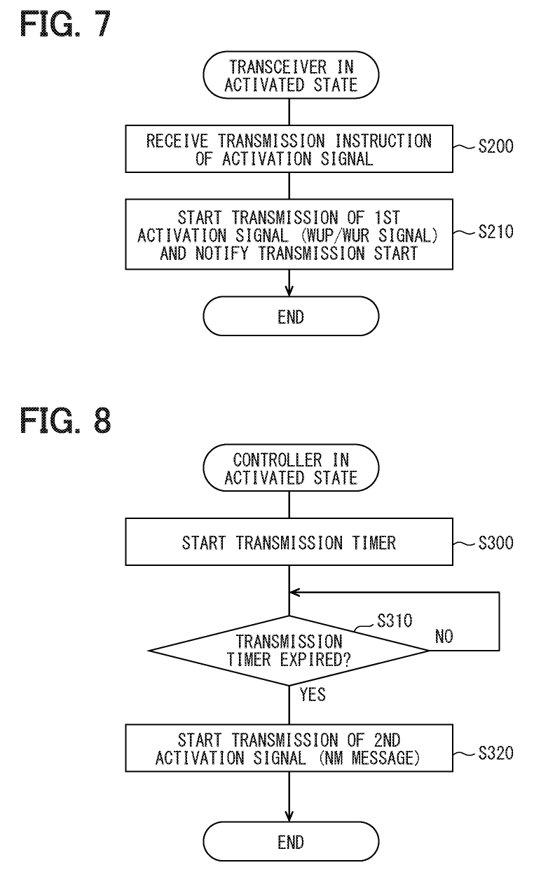

The following will describe a process, which is executed by an activated transceiver 4, for activating another node with reference to FIG. 7.

In S200, the transceiver 4 receives the transmission instruction of activation signal, similar to the process in S10.

In S210, the transceiver 4 generates the first activation signal, starts transmission of the first activation signal, and notifies the controller 3 that transmission of the first activation signal has started. Thereafter, the transceiver 4 ends the current process.

The following will describe, a process, which is executed by an activated controller 3, for activating another node with reference to FIG. 8. The controller 3 starts this process upon receiving the notification from the transceiver 4 about transmission start of the first activation signal.

In S300, the controller 3 starts the transmission timer from the transmission start time of the first activation signal.

In S310, the controller 3 determines whether the transmission timer has expired. When the controller 3 determines that the transmission timer has expired, the process proceeds to S320. When the controller 3 determines that the transmission timer has not expired, the process repeats S310.

In S320, the controller 3 generates the second activation signal and starts transmission of the second activation signal. Thereafter, the controller 3 ends the current process.

### 2-3. Effects

According to the second embodiment described in detail above, the effects (1) to (6) of the first embodiment described above are obtained, and the following effect is further obtained.

(7) Since the controller 3 generates the second activation signal, the processing load of the transceiver 4 can be reduced.

### OTHER EMBODIMENTS

Although the embodiments of the present disclosure have been described above, the present disclosure is not limited to the above-described embodiments and can be implemented in various modified forms.

Multiple functions implemented by one component in the above embodiments may be implemented by multiple components, and one function implemented by one component may be implemented by multiple components. Multiple functions of multiple elements may be implemented by one element, or one function implemented by multiple elements may be implemented by one element. In each of the above embodiments, a part of the configuration may be properly omitted. At least a part of the configuration of the above embodiment may be added to or substituted for the configuration of another embodiment.

What is claimed is:

1. A transceiver connected to an on-board communication line, the transceiver comprising
at least one circuit including a detection unit configured to detect standardized signals communicated on the on-board communication line, the standardized signals being standardized according to the on-board communication line and including a first activation signal and a second activation signal,
wherein,
after the detection unit detects the first activation signal on the on-board communication line, the transceiver is configured to be completely activated in response to the detection unit detecting the second activation signal on the on-board communication line within a predetermined period of time after detection of the first activation signal, and
the second activation signal is different from the first activation signal and includes identification information for identifying the transceiver.

2. The transceiver according to claim 1, wherein
the first activation signal partially activates the transceiver, and
the second activation signal completely activates the transceiver.

3. The transceiver according to claim 1, wherein
the on-board communication line is an ethernet communication line, and
the first activation signal is a wake-up pulse signal or a wake-up request signal defined by technical committee 10.

4. The transceiver according to claim 3, wherein
the second activation signal is a user datagram protocol network management packet defined by automotive open system architecture.

5. The transceiver according to claim 1, wherein
the identification information is virtual local area network identification.

6. The transceiver according to claim 1, wherein
the identification information is partial network information.

7. A method for activating a transceiver connected to an on-board communication line, the method comprising:
detecting a first activation signal communicated on the on-board communication line, the first activation signal being a signal standardized on the on-board communication line; and
after detecting the first activation signal on the on-board communication line, in response to detecting a second activation signal on the on-board communication line within a predetermined period of time after detection of the first activation signal, completely activating the transceiver, the second activation signal being a signal standardized on the on-board communication line,
wherein the second activation signal is different from the first activation signal and includes identification information for identifying a network to which the transceiver is included.

8. The method according to claim 7, wherein
detecting the first activation signal includes partially activating the transceiver.

9. The method according to claim 7, wherein
the on-board communication line is an ethernet communication line, and
the first activation signal is a wake-up pulse signal or a wake-up request signal defined by technical committee 10.

10. The method according to claim 9, wherein
the second activation signal is a user datagram protocol network management packet defined by automotive open system architecture.

11. A communication system comprising:
a transmitting device;
a receiving device;
a control device; and
an on-board communication line to which the transmitting device, the receiving device, and the control device are connected,
wherein
the transmitting device is configured to generate and transmit a first activation signal to the on-board communication line, the first activation signal is a signal standardized on the on-board communication line,
the receiving device is configured to receive signals standardized on the on-board communication line,
the control device is configured to be completely activated when the receiving device receives a second activation signal, which is different from the first activation signal, within a predetermined period of time after receiving the first activation signal, and
the second activation signal includes identification information for identifying the receiving device on the on-board communication line.

12. The communication system according to claim 11, wherein
the receiving device is configured to be partially activated in response to receiving the first activation signal, and
the receiving device is configured to be completely activated in response to receiving the second activation signal.

13. The communication system according to claim 11, wherein
the on-board communication line is an ethernet communication line, and
the first activation signal is a wake-up pulse signal or a wake-up request signal defined by technical committee 10.

14. The communication system according to claim 13, wherein
the second activation signal is a user datagram protocol network management packet defined by automotive open system architecture.

15. A communication system comprising
a transmitting device;
a receiving device;
a first control device;
a second control device; and
an on-board communication line to which the transmitting device, the receiving device, the first control device, and the second control device are connected,
wherein
the transmitting device is configured to generate and transmit a first activation signal, which is a signal standardized on the on-board communication line,
the first control device is configured to generate and transmit a second activation signal, which is a signal standardized on the on-board communication line after the first activation signal is transmitted to the on-board communication line, the second activation signal includes identification information for identifying the receiving device connected to the on-board communication line,
the receiving device is configured to receive the signals standardized on the on-board communication line, and
the second control device is completely activated in response to the receiving device receiving the second activation signal within a predetermined period of time after receiving the first activation signal.
